(19) United States
(12) Patent Application Publication
(10) Pub. No.: US 2026/0291059 A1
(43) Pub. Date: Sep. 24, 2026

(54) ANTENNA DEVICE AND ELECTRONIC DEVICE INCLUDING THE SAME

(71) Applicant: DONGWOO FINE-CHEM CO., LTD., Jeonbuk-do (KR)

(72) Inventors: YOON HO HUH, Jeonbuk-do (KR); DO HYOUNG KWON, Jeonbuk-do (KR); WON HEE LEE, Jeonbuk-do (KR); JONG SU LEE, Jeonbuk-do (KR); SUNG JOON HONG, Jeonbuk-do (KR)

(21) Appl. No.: 19/569,393

(22) Filed: Mar. 17, 2026

(30) Foreign Application Priority Data
Mar. 18, 2025 (KR) 10-2025-0034551

(51) Int. Cl. H01Q 1/36; H01Q 1/27

(52) U.S. Cl. CPC H01Q 1/36; H01Q 1/273

(57) ABSTRACT

An antenna device includes an antenna dielectric layer having a curved circumference and a radiator extending along the curved circumference of the antenna dielectric layer and having a curved shape. The radiator includes a solid portion and a mesh portion. Lateral sides of one end portions of the solid portion and the mesh portion are included in the same straight line, and lateral sides of the other end portions of the solid portion and the mesh portion are separated from each other.

### CROSS REFERENCE TO RELATED APPLICATIONS AND CLAIM OF PRIORITY

This application claims the benefit under 35 U.S.C. § 119 of Korean Patent Application No. 10-2025-0034551 filed on Mar. 18, 2025, in the Korean Intellectual Property Office, the entire disclosure of which is incorporated herein by reference for all purposes.

### BACKGROUND

### 1. Field

The present invention relates to an antenna device and an electronic device including the same. More particularly, the present invention relates to an antenna device including a radiator and a dielectric layer, and an electronic device including the same.

### 2. Description of the Related Art

With recent developments of information society, wireless communication technologies such as Wi-Fi and Bluetooth are applied or embedded in image display devices, electronic devices and buildings. With a recent evolution of mobile communication technology, an antenna for performing, e.g., high-frequency or ultra-high frequency band communication is being applied to public transportation such as a bus and a subway, a building structure, various mobile devices, wearable devices, and the like.

For example, when the antenna is applied to an electronic device such as an image display device, mutual interference may occur between a conductor such as an electrode and a wiring included in the electronic device, and the antenna.

Further, if the antenna covers a display area of the image display device or the antenna is visually recognized by the user, image properties of the image display device may be deteriorated.

Accordingly, a space within an electronic device to which the antenna may be inserted or applied may be limited. Desired frequency band and radiation properties may not be easily implemented within the limited space.

### SUMMARY

According to an aspect of the present invention, there is provided an antenna device having improved radiation properties and electrical properties.

According to an aspect of the present invention, there is provided an electronic device including an antenna device having improved radiation properties and electrical properties.
(1) An antenna device, including: an antenna dielectric layer having a curved circumference; and a radiator extending along the curved circumference of the antenna dielectric layer and having a curved shape, the radiator including a solid portion and a mesh portion, wherein lateral sides of one end portions of the solid portion and the mesh portion are included in the same straight line, and lateral sides of the other end portions of the solid portion and the mesh portion are separated from each other.
(2) The antenna device of the above (1), wherein the antenna dielectric layer has a circular shape, and the radiator has an arc shape of a circular sector.
(3) The antenna device of the above (1), wherein an orientation angle difference between a first orientation angle of the solid portion and a second orientation angle of the mesh portion is in a range from 10° to 40°, the first orientation angle is an angle between a virtual horizontal line extending from a starting point of an outer circumference of the solid portion in a tangential direction to the outer circumference of the solid portion and a first virtual straight line extending from the starting point of the outer circumference of the solid portion toward an end point of an inner circumference of the solid portion, and the second orientation angle is an angle between the virtual horizontal line and a second virtual straight line extending from the starting point of the outer circumference of the solid portion toward an end point of an inner circumference of the mesh portion.
(4) The antenna device of the above (3), wherein the orientation angle difference is in a range from 15° to 35°.
(5) The antenna device of the above (3), wherein an outer circumference of the mesh portion and the inner circumference of the solid portion are in contact with each other.
(6) The antenna device of the above (1), wherein a ratio of a length of the mesh portion relative to a length of the solid portion is 0.5 or greater, and less than 1.
(7) The antenna device of the above (1), wherein a width of the mesh portion is greater than a width of the solid portion.
(8) The antenna device of the above (1), wherein a ratio of a sheet resistance of the mesh portion relative to a sheet resistance of the solid portion of the radiator is in a range from 10 to 70.
(9) The antenna device of the above (1), further including a circuit board that includes: a core layer; and a signal wiring disposed on one surface of the core layer to be electrically connected to the radiator.
(10) The antenna device of the above (9), wherein the circuit board further includes a co-planar ground disposed at the same level as that of the signal wiring on the one surface of the core layer and spaced apart from the signal wiring.
(11) The antenna device of the above (9), wherein the circuit board further includes a vertical ground disposed on the other surface of the core layer opposite to the one surface to overlap the signal wiring.
(12) The antenna device of the above (1), wherein the mesh portion consists of first conductive lines and second conductive lines which intersect each other to form openings.
(13) The antenna device of the above (1), wherein the solid portion and the mesh portion have the same curvature.
(14) The antenna device of the above (1), wherein the antenna device provides a dual resonance frequency in a frequency band ranging from 1 GHz to 15 GHz.
(15) An electronic device, including: a display panel; and the above-described antenna device disposed on the display panel.
(16) The electronic device according to the above (15), wherein the electronic device is provided as a smartwatch.
(17) The electronic device according to the above (16), wherein the electronic device has a display area and a peripheral area, and the solid portion of the radiator overlaps the peripheral area, and the mesh portion overlaps the display area.
(18) The electronic device according to the above (15), further including a rear board disposed under the display panel and having a second connection structure mounted thereon, wherein the antenna device further includes a circuit board connected to the radiator and having a first connection structure mounted thereon, and the circuit board is bent toward the rear board such that the first connection structure and the second connection structure are coupled to each other.
(19) The electronic device of the above (18), wherein the first connection structure is a first connector or a pogo pin, and the second connection structure is a second connector coupled to the first connector or a pin pad connected to the pogo pin.

An antenna device according to embodiments may include a curved radiator extending along a curved circumference on a top surface of a dielectric layer having the curved circumference. Accordingly, antenna radiation properties may be achieved while avoiding an interference with electrical/optical properties of an electronic device to which the antenna device is applied.

In example embodiments, the radiator may include a solid portion and a mesh portion. Accordingly, visual recognition of the antenna may be prevented and sufficient radiation properties may be achieved. Additionally, a plurality of radiation frequency bands may be achieved by adjusting an orientation of the solid portion and the mesh portion.

The antenna device may be applied to an electronic device having a curved circumference such as an image display device and a wearable device such as a smart watch, so that the electronic device providing high-frequency or ultra-high-frequency communication can be effectively implemented.

### BRIEF DESCRIPTION OF THE DRAWINGS

FIG. 1 is a schematic plan view illustrating an antenna device according to embodiments.

FIG. 2 is a schematic partially enlarged plan view illustrating a radiator of an antenna device according to embodiments.

FIG. 3 is a schematic partially enlarged plan view illustrating a radiator of an antenna device according to embodiments.

FIG. 4 is a schematic plan view illustrating an antenna device according to embodiments.

FIG. 5 is a schematic cross-sectional view illustrating an antenna device according to embodiments.

FIG. 6 is a schematic perspective view illustrating an electronic device according to embodiments.

FIG. 7 is a schematic cross-sectional view illustrating an electronic device according to embodiments.

FIG. 8 is a graph showing a gain according to a frequency of an antenna sample.

### DETAILED DESCRIPTION OF THE EMBODIMENTS

Embodiments of the present invention provide an antenna device including a dielectric layer and a radiator having a curved shape. Embodiments of the present invention provide an electronic device including the antenna device.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “first,” “second,” “third,” “one end,” “the other end,” “upper side,” “lower side,” “lateral side”, etc., herein are used to relatively distinguish positions of components, and are not intended to designate absolute positions.

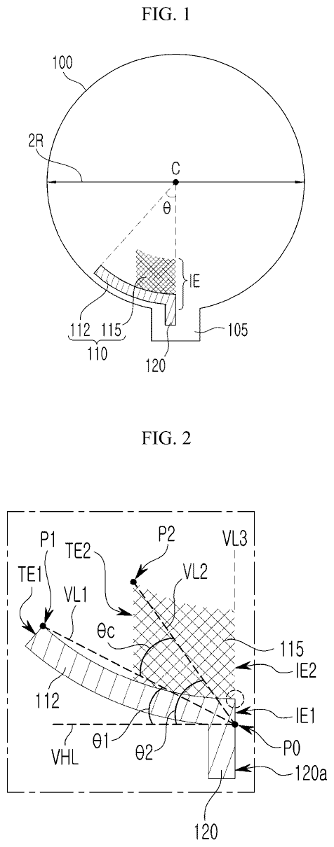

FIG. 1 is a schematic plan view illustrating an antenna device according to embodiments.

Referring to FIG. 1, an antenna device may include an antenna dielectric layer 100 and a radiator 110 disposed on the antenna dielectric layer 100 and having a curved shape.

In some embodiments, the antenna dielectric layer 100 may include a transparent resin material. For example, the antenna dielectric layer 100 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more therefrom.

In an embodiment, the antenna dielectric layer 100 may include a cyclic olefin polymer (COP)-based material.

In some embodiments, an adhesive film such as an optically clear adhesive (OCA) or an optically clear resin (OCR) may be included in the antenna dielectric layer 100.

In some embodiments, the antenna dielectric layer 100 may include an inorganic insulating material such as silicon oxide, silicon nitride, silicon oxynitride, glass, etc.

In an embodiment, the antenna dielectric layer 100 may be provided as a substantially single layer.

In some embodiments, the antenna dielectric layer 100 may include a multi-layered structure of at least two or more layers. For example, the antenna dielectric layer 100 may include a substrate layer and an antenna dielectric layer, and may include an adhesive layer between the substrate layer and the antenna dielectric layer.

An impedance or an inductance of the antenna unit may be formed by the antenna dielectric layer 100 so that a frequency band in which the antenna structure may be driven or operated may be adjusted. In some embodiments, a dielectric constant of the antenna dielectric layer 100 may be adjusted in a range from about 1.5 to about 12. When the dielectric constant is greater than about 12, a driving frequency may be excessively reduced and driving in a high frequency band may not be implemented.

In some embodiments, a connection support layer 105 may be connected to the antenna dielectric layer 100. The connection support layer 105 may be provided as a dielectric layer supporting electrical bonding or adhesion of a circuit board 150 and a pad portion 120 as will be described later.

The connection support layer 105 may have a bar shape protruding from the antenna dielectric layer 100. The connection support layer 105 may include substantially the same material as that of the antenna dielectric layer 100, and may be formed of a single member substantially integral with the antenna dielectric layer 100.

According to embodiments of the present invention, the antenna dielectric layer 100 may have a curved circumference. In some embodiments, the antenna dielectric layer 100 may have a substantially circular or elliptical shape.

The radiator 110 may have a curved shape extending along the curved circumference of the antenna dielectric layer 100. In example embodiments, the radiator 110 may extend in the curved shape along the curved circumference of the antenna dielectric layer 100 from a specific point of the circumference of the antenna dielectric layer 100.

In example embodiments, the radiator 110 and the curved circumferences of the antenna dielectric layer 100 may have substantially the same curvature.

The radiator 110 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy containing at least one thereof. These may be used alone or in a combination of two or more therefrom.

In an embodiment, the radiator 110 may include silver (Ag) or a silver alloy (e.g., a silver-palladium-copper (APC) alloy), or copper (Cu) or a copper alloy (e.g., a copper-calcium (CuCa) alloy) for low resistance implementation and fine line width patterning.

In some embodiments, the radiator 110 may substantially consist of the above-described metal or alloy.

The antenna device may further include the pad portion 120 connected to the radiator 110. The pad portion 120 may be disposed on the connection support layer 105 to be electrically connected to a signal wiring 170 (see FIG. 4) included in the circuit board 150.

The radiator 110 may have a shape bent from the pad portion 120, and may extend clockwise or counterclockwise from the pad portion 120. The pad portion 120 may include substantially the same material as that of the radiator 110, and may be formed as a single member substantially integral with the radiator 110.

In example embodiments, one lateral side of the pad portion 120 and one lateral side of the radiator 110 may substantially coincide with each other. For example, one lateral side of the pad portion 120 and one lateral side of one end portion of the radiator 110 may be integrally connected to form the same straight line.

One end portion IE of the radiator 110 may be an initiating end portion extending from the pad portion 120.

According to embodiments of the present invention, the radiator 110 may include a solid portion 112 and a mesh portion 115.

The solid portion 112 may include the above-described metal or alloy, and may refer to one continuous layer without an opening. The mesh portion 115 may include openings formed by conductive lines crossing each other as will be described later.

The solid portion 112 may be adjacent to the curved circumference of the antenna dielectric layer 100, and the mesh portion 115 may be closer to an inner region of the top surface of the antenna dielectric layer 100 than the solid portion 112. The solid portion 112 may have a predetermined separation distance from the curved circumference of the antenna dielectric layer 100.

In example embodiments, the solid portion 112 and the mesh portion 115 may have substantially the same curvature, and may extend together from the one end portion IE along the curved circumference of the antenna dielectric layer 100.

In some embodiments, a length of the curved circumference of the antenna dielectric layer 100 may be calculated as 2πR. As illustrated in FIG. 1, R may correspond to a radius of the curved circumference, and 2R may correspond to a diameter of the curved circumference.

In some embodiments, the solid portion 112 has an arc shape of a circular sector, and a length of the solid portion 112 may correspond to a length of the arc. For example, the length of the solid portion 112 may be calculated by Equation 1 below.

length of solid portion=(R−SD)*θ [Equation 1]

In Equation 1, R represents the radius around the curved circumference of the antenna dielectric layer 100. SD represents a separation distance of the solid portion 112 from the curved circumference of the antenna dielectric layer 100. θ represents an intersection angle between a straight line connecting one end of the solid portion and a center C and a straight line connecting the other end of the solid portion and the center C.

In some embodiments, a central angle of the circular sector or the intersection angle θ may be 90° or less. In an embodiment, the intersection angle θ may be in a range from 10° to 80°, from 15° to 70°, or from 30° to 70°.

A ratio of the length of the radiator 110 to the curved circumference of the antenna dielectric layer 100 may be adjusted to an appropriate range in the intersection angle range. For example, a sufficient antenna gain may be achieved while suppressing radiation cancellation according to the curved shape of the radiator 110.

According to embodiments of the present invention, the solid portion 112 and the mesh portion 115 may be provided as a single member integrally connected with each other. The pad portion 120 may be integrally connected to the solid portion 112.

In example embodiments, one end portions of the solid portion 112 and the mesh portion 115 may form the same one end portion IE. The other end portions of the solid portion 112 and the mesh portion 115 may not coincide with each other or may be discontinuous.

Structure and orientation of the solid portion 112 and the mesh portion 115 will be described in more detail with reference to FIG. 2.

FIG. 2 is a partially enlarged plan view schematically illustrating a radiator of an antenna device according to embodiments.

Referring to FIG. 2, lateral sides of one end portion IE1 of the solid portion 112 and one end portion IE2 of the mesh portion 115 may substantially coincide with each other. In example embodiments, lateral sides of the one end portion IE1 of the solid portion 112 and the one end portion IE2 of the mesh portion 115 may be included together in a third virtual straight line VL3.

In some embodiments, one lateral side 120a of the pad portion 120, and lateral sides of the one end portion IE1 of the solid portion 112 and the one end portion IE2 of the mesh portion 115 may substantially coincide with each other. Accordingly, the one lateral side 120a of the pad portion 120, the lateral side of the one end portion IE1 of the solid portion 112, and the lateral side of the one end portion IE2 of the mesh portion 115 may be continuously connected to be included in the third virtual straight line VL3.

In example embodiments, lateral sides of the other end portion TE1 of the solid portion 112 and the other end portion TE2 of the mesh portion 115 may be substantially separated or discontinuous.

In some embodiments, a length of the mesh portion 115 may be less than a length of the solid portion 112. In some embodiments, a width of the mesh portion 115 may be greater than a width of the solid portion 112.

In an embodiment, a ratio of the length of the mesh portion 115 relative to the length of the solid portion 112 may be 0.5 or greater and less than 1. In an embodiment, the ratio of the length of the mesh portion 115 relative to the length of the solid portion 112 may be in a range from 0.5 to 0.9, or from 0.5 to 0.8.

The length of the solid portion 112 may be calculated according to Equation 1 as described above. The length of the solid portion 112 may be a length of an outer circumference adjacent to the curved circumference of the antenna dielectric layer 100. The length of the mesh portion 115 may be a length of a circumference in contact with the solid portion 112.

For example, an outer circumference of the mesh portion 115 may be in contact with an inner circumference of the solid portion 112, and the length of the mesh portion 115 may be a length of the outer circumference.

The width of the solid portion 112 and the width of the mesh portion 115 may be lengths of the lateral sides of the one end portions IE1 and IE2, respectively.

In example embodiments, an orientation angle difference θc between the solid portion 112 and the mesh portion 115 may be in a range of 10° to 40°. In the angle difference range, mutual interference with conductors included in the electronic device may be suppressed while achieving radiation properties (e.g., dual resonance peaks) of a plurality of frequency bands.

For example, if the orientation angle difference is excessively increased, a field interference between the mesh portion 115 and electrodes included in electronic devices or a display panel may be increased, and dual resonance radiation properties may not be substantially implemented. If the orientation angle difference is excessively reduced, an overall antenna gain may be reduced and the dual resonance radiation properties may not be substantially implemented.

The orientation angle difference θc between the solid portion 112 and the mesh portion 115 may be a difference between a second orientation angle θ2 of the mesh portion 115 and a first orientation angle θ1 of the solid portion 112. The second orientation angle θ2 may be greater than the first orientation angle θ1.

The first orientation angle θ1 of the solid portion 112 may be an angle between a virtual horizontal line VHL and a first virtual straight line VL1. The virtual horizontal line VHL may be a straight line extending from a starting point P0 of the outer circumference of the solid portion 112 in a tangential direction of the outer circumference of the solid portion 112.

The first virtual straight line VL1 may be a straight line extending the starting point P0 of the outer circumference of the solid portion 112 to an end point P1 of the inner circumference of the solid portion 112. The starting point P0 may be a point where a virtual extension line of the outer circumference of the solid portion 112 meets the lateral side 120a of the pad portion 120 or the lateral side of the one end portion IE1 of the solid portion 112. The end point P1 may be a point where the inner circumference of the solid portion 112 and the lateral side of the other end portion TE1 meet each other.

The second orientation angle θ2 of the mesh portion 115 may be an angle between the virtual horizontal line VHL and a second virtual straight line VL2. The second virtual straight line VL2 may be a straight line from the starting point P0 of the outer circumference of the solid portion 112 to an end point P2 of the inner circumference of the mesh portion 115. The end point P2 may be a point at which the inner circumference of the mesh portion 115 and the lateral side of the other end portion TE2 meet each other.

In some embodiments, the orientation angle difference θc between the solid portion 112 and the mesh portion 115 may be in a range from 10° to 35°, from 15° to 35°, from 10° to 30°, or from 15° to 30°. In the above range, the dual resonance frequency formation and the prevention of interference with the electronic device/display panel may be more effectively implemented.

According to the above-described example embodiments, interference of image properties and electrical properties implemented in the electronic device to which the antenna device is applied may be reduced while increasing transparency of the radiator 110 by the mesh portion 115. Additionally, the solid portion 112 may be disposed around an outer circumference of the antenna dielectric layer 100, so that a sufficient antenna gain may be obtained while increasing feeding efficiency to the radiator 110.

As described above, boundaries of the one end portions IE1 and IE2 of the solid portion 112 and the mesh portion 115 may be located substantially on the same line, and boundaries of the other end portions TE1 and TE2 may be separated. Thus, the number of radiation bands implemented from the radiator 110 may be increased while improving an overall spatial efficiency of the radiator 110 and image properties of the electronic device.

In some embodiments, a ratio of a sheet resistance of the mesh portion 115 relative to a sheet resistance of the solid portion 112 in the radiator 110 may be in a range from 10 to 70. In the above ratio range, an excessive decrease in antenna gain and radiation efficiency by the introduction of the mesh portion 115 may be prevented, and interference of electrical/image properties and a luminance reduction of the electronic device may be effectively suppressed.

In an embodiment, the sheet resistance ratio may be in a range from 10 to 60, from 10 to 50, from 20 to 60, from 20 to 50, from 10 to 40, or from 20 to 40.

In an embodiment, a total line width of the radiator 110 may be in a range from 200 μm to 1,500 μm, from 300 μm to 1,500 μm, from 400 μm to 1,300 μm, or from 400 μm to 1,000 μm.

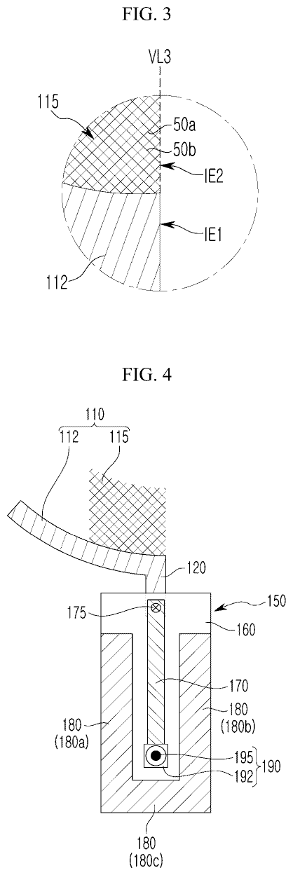

FIG. 3 is a partially enlarged plan view schematically illustrating a radiator of an antenna device according to embodiments. For example, FIG. 3 is a partially enlarged plan view of an area indicated by a dotted circle of FIG. 2.

Referring to FIG. 3, the mesh portion 115 may include first conductive lines 50a and second conductive lines 50b. The first conductive line 50a and the second conductive line 50b may cross each other and may be repeatedly arranged.

The first conductive line 50a and the second conductive line 50b may extend obliquely with respect to an extending direction of the third virtual straight line VL3. For example, the first conductive line 50a may be inclined at a predetermined acute angle in a clockwise direction with respect to the third virtual straight line VL3. The second conductive line 50b may be inclined at a predetermined acute angle in the counterclockwise direction with respect to the third virtual straight line VL3.

A plurality of the first conductive lines 50a may be repeatedly arranged by a predetermined interval along an extending direction of the second conductive line 50b. A plurality of the second conductive lines 50b may be repeatedly arranged by a predetermined interval along an extending direction of the first conductive line 50a.

Accordingly, the neighboring first conductive lines 50a and the neighboring second conductive lines 50b intersect with each other, and the mesh portion 115 in which, e.g., rhombus unit cells (openings) are formed may be formed.

The mesh portion 115 may substantially consist of first conductive lines 50a and second conductive lines 50b. In example embodiments, the mesh portion 115 may not include additional conductors other than the first conductive lines 50a and the second conductive lines 50b.

In some embodiments, the mesh portion 115 may not include an additional edge pattern or an additional edge conductive line connecting ends of the first conductive lines 50a and the second conductive lines 50b to each other.

For example, a side of the one end portion IE2 of the mesh portion 115 may be defined by a virtual straight line connecting the ends of the first conductive lines 50a and the second conductive lines 50b. The virtual straight line may substantially coincide with the third virtual straight line VL3.

As described above, the mesh portion 115 may be formed only by the first and second conductive lines 50a and 50b while omitting an additional edge pattern. Accordingly, the radiator 110 may be prevented from being visually recognized due to the introduction of the additional conductive pattern while improving image properties of the electronic device.

According to embodiments, the resonance frequency band of the antenna element AE may cover LTE, WIFI, UWB and satellite communication bands. In some embodiments, the resonance frequency band of the antenna element AE may be in a range from 1 GHz to 15 GHz, from 2 GHz to 15 GHz, from 3 GHz to 15 GHz, from 4 GHz to 15 GHz, or from 5 GHz to 15 GHz.

In some embodiments, two resonance peaks or resonance frequencies may be implemented in the above-described frequency band range. Accordingly, dual radiation properties may be implemented.

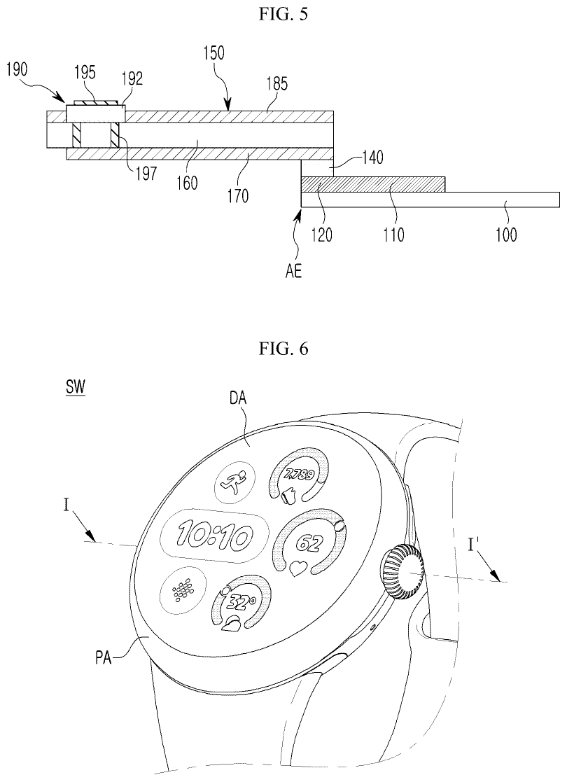

FIG. 4 is a schematic plan view illustrating an antenna device according to embodiments. FIG. 5 is a schematic cross-sectional view illustrating an antenna device according to embodiments. For convenience of illustration and description, illustration of the antenna dielectric layer 100 is omitted in FIG. 4.

Referring to FIGS. 4 and 5, the antenna device may further include a circuit board 150 electrically connected to the radiator 110. The antenna element AE including the above-described antenna dielectric layer 100 and the radiator 110 (including the pad portion 120) may be provided, and the circuit board 150 may be coupled to the antenna element AE. Accordingly, the antenna device in the form of a module or a package may be provided.

The circuit board 150 may include a core layer 160 and a signal wiring 170 formed on one surface of the core layer 160. The core layer 160 may include a flexible resin such as a polyimide resin, a modified polyimide (MPI), an epoxy resin, a polyester, a cyclo olefin polymer (COP), a liquid crystal polymer (LCP), or the like. In a preferable embodiment, the core layer 160 may include the polyimide resin or the MPI.

In example embodiments, the circuit board 150 may be a flexible printed circuit board (FPCB) including the above-described flexible resin.

One end portion of the signal wiring 170 may be electrically connected to the pad portion 120. Accordingly, feeding and signal transfer may be performed to the radiator 110 through the signal wiring 170.

The other end portion of the signal wiring 170 may be connected to a first connection structure 190. The first connection structure 190 may be mounted on a surface of the core layer 160 by, e.g., a surface mounting technology (SMT).

The first connection structure 190 may include an insulator 192 and an external connection conductor 195 coupled to the insulator 192.

The one end portion of the signal wiring 170 may be electrically connected to the pad portion 120 of the antenna element AE through a conductive intermediate structure such as a contact 175 or an anisotropic conductive film 140.

In an embodiment, as illustrated in FIG. 4, the one end portion of the signal wiring 170 may be electrically connected to the pad portion 120 of the antenna element AE through the contact 175 penetrating the core layer 160. In this case, the signal wiring 170 and the first connection structure 190 may be disposed together on an outer surface of the core layer 160.

In an embodiment, as illustrated in FIG. 5, the one end portion of the signal wiring 170 may be electrically connected to the pad portion 120 of the antenna element AE through the anisotropic conductive film 140.

For example, the one end portion of the signal wiring 170 and the pad portion 120 may be heated and compressed with the anisotropic conductive film 140 interposed therebetween. Accordingly, an electrical connection between the signal wiring 170 and the pad portion 120 may be implemented.

In this case, the signal wiring 170 may be disposed on an inner surface of the core layer 160, and the first connection structure 190 may be disposed on the outer surface of the core layer 160. The first connection structure 190 may include a signal pin 197 penetrating the core layer 160. The first connection structure 190 may be in contact with or electrically connected to the signal wiring 170 through the signal pin 197. The signal pin 197 may be connected to the external connection conductor 195 within the insulator 192.

The inner surface of the core layer 160 may refer to a surface adjacent to the antenna element AE of the circuit board 150 or the core layer 160. The outer surface of the core layer 160 may refer to a surface facing the inner surface. Based on the cross-section of FIG. 5, the outer surface and the inner surface of the core layer 160 may correspond to an upper surface and a lower surface of the core layer 160, respectively.

In some embodiments, the circuit board 150 may further include a co-planar ground 180. The co-planar ground 180 may include a portion disposed at the same level or on the same plane as that of the signal wiring 170 and extending to be substantially parallel to the signal wiring 170.

As illustrated in FIG. 4, the co-planar ground 180 may include a first portion 180a and a second portion 180b facing each other with the signal wiring 170 interposed therebetween. The first portion 180a and the second portion 180b may be physically separated from the signal wiring 170 and may be substantially parallel to the signal wiring 170.

In some embodiments, the co-planar ground 180 may further include a connection portion 180c connecting end portions of the first portion 180a and the second portion 180b.

In some embodiments, the circuit board 150 may further include a vertical ground 185 facing the signal wiring 170 with the core layer 160 interposed therebetween. When the signal wiring 170 is disposed on the outer surface of the core layer 160, the vertical ground 185 may be disposed on the inner surface of the core layer 160. When the signal wiring 170 is disposed on the inner surface of the core layer 160, the vertical ground 185 may be disposed on the outer surface of the core layer 160.

Noises around the signal wiring 170 may be blocked by the co-planar ground 180, and an electric field concentration to the antenna element AE may be promoted. Noises directed to the circuit board 150 from an electronic device or an external environment may be additionally blocked by the vertical ground 185, and the electric field concentration may be further increased.

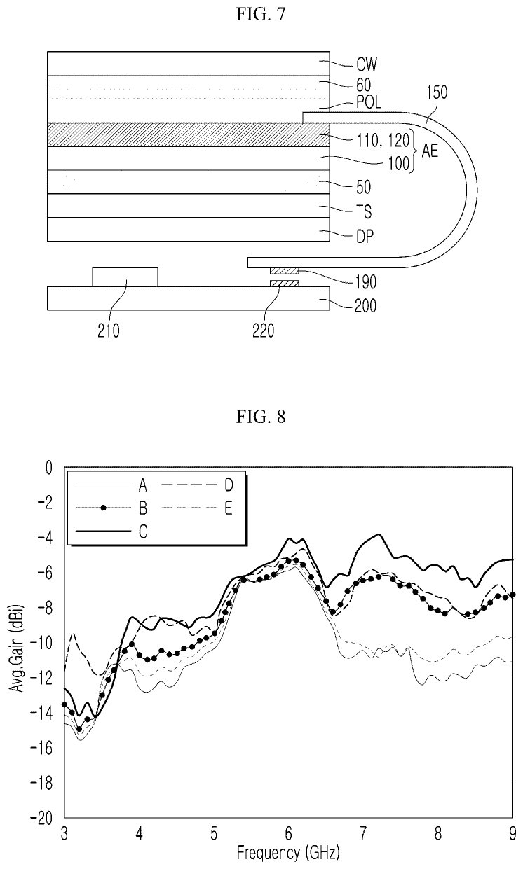

FIG. 6 is a schematic perspective view illustrating an electronic device according to embodiments. FIG. 7 is a schematic cross-sectional view illustrating an electronic device according to embodiments. For example, FIG. 7 is a cross-sectional view taken along a line I-I′ of FIG. 6 in a thickness direction.

In example embodiments, the electronic device may include a display device. In some embodiments, the electronic device may include a wearable device including a display device. In an embodiment, the electronic device may include a smart watch SW, as illustrated in FIG. 6.

Referring to FIG. 6, e.g., an electronic device implemented in the form of the smart watch SW may include a circular body, and the circular body may include a display area DA and a peripheral area PA. The peripheral area PA may be substantially a bezel area of the circular body.

The radiator 110 of the antenna element AE may extend along the peripheral area PA. In example embodiments, the solid portion 112 of the radiator 110 may be disposed in the peripheral area PA, and the mesh portion 115 of the radiator 110 may be disposed in the display area DA.

In an embodiment, a boundary between the mesh portion 115 and the solid portion 112 may substantially coincide with a boundary between the display area DA and the peripheral area PA.

In an embodiment, a portion of the mesh portion 115 may be disposed in the peripheral area PA. In an embodiment, a portion of the solid portion 112 may be disposed in the display area DA.

Referring to FIG. 7, the electronic device may include a display panel DP and the antenna device stacked on the display panel DP. The electronic device may further include a cover window CW disposed on the antenna device to provide a display screen or an outermost surface of FIG. 6.

The display panel DP may include, e.g., a thin film transistor (TFT) array substrate. The display panel DP may be disposed on the TFT array substrate, and may include a display element including a stack of an anode-a display layer-a cathode. For example, the display layer may include an organic emission layer, and the display element may be an organic light-emitting diode (OLED) element.

The antenna element AE may be disposed on the display panel DP. In some embodiments, a touch sensor layer TS may be disposed between the antenna element AE and the display panel DP.

In an embodiment, the touch sensor layer TS may include a sensor substrate layer and sensing electrodes arranged on the sensor substrate layer. In an embodiment, the touch sensor layer TS may be included as an on-cell type sensor including sensing electrodes directly formed on the display panel DP.

A first adhesive layer 50 may be formed between the antenna element AE and the display panel DP. For example, the first adhesive layer 50 may be formed between the antenna element AE and the touch sensor layer TS.

In some embodiments, a polarizing layer POL may be stacked on the antenna element AE. The polarizing layer POL may include a coated polarizer or a polarizing plate. The coated polarizer may include a liquid crystal coating layer including a polymerizable liquid crystal compound and a dichroic dye. In this case, the polarizing layer POL may further include an alignment layer for generating an orientation to the liquid crystal coating layer.

For example, the polarizing plate may include a polyvinyl alcohol-based polarizer and a protective film attached to at least one surface of the polyvinyl alcohol-based polarizer.

The cover window CW may include, e.g., glass or a transparent resin film. In some embodiments, a light-shielding pattern may be formed on a peripheral portion of one surface of the cover window CW. The light-shielding pattern may include, e.g., a color printing pattern, and may have a single-layered structure or a multi-layered structure. The peripheral area PA or the bezel area may be defined by the light-shielding pattern.

For example, a second adhesive layer 60 may be formed between the polarizing layer POL and the cover window CW. In some embodiments, an adhesive layer may be formed between the antenna element AE and the polarizing layer POL.

The electronic device may further include a rear board 200 disposed under the display panel DP. In example embodiments, the rear board 200 may be a main board in the form of a rigid circuit board. A circuit element 210 and a second connection structure 220 may be mounted on the rear board 200. In some embodiments, pads for an electrical connection with the circuit board 150 may be formed on the rear board 200.

For example, the circuit element 210 may include a display driving integrated circuit chip for driving the TFT array substrate, a touch sensor driving integrated circuit chip, an antenna driving integrated circuit chip, an AP (application) processor, or the like. The second connection structure 220 may be electrically connected to the antenna driving integrated circuit chip through a wiring included in the rear board 200.

One end portion of the circuit board 150 may be coupled to the pad portion 120 of the antenna device AE. The circuit board 150 may be bent downward with respect to the antenna element AE so that the first connection structure 190 mounted on the other end portion of the circuit board 150 and the second connection structure 220 mounted on the rear board 200 may be coupled to each other.

Accordingly, an electrical connection structure between the antenna driving integrated circuit chip-the circuit board 150—the antenna element AE may be implemented.

Each of the first connection structure 190 and the second connection structure 220 may include a connector, a pogo pin, a c-clip, or the like.

In an embodiment, the first connection structure 190 may be a first connector, and the second connection structure 220 may be a second connector coupled to the first connector.

In an embodiment, the first connection structure 190 may be a pogo pin, and the second connection structure 220 may be a pin pad in contact with or connected to the pogo pin.

As described above, the solid portion 112 and the mesh portion 115 may be included in the radiator 110 together to suppress electrical interference with the display panel DP and/or the touch sensor layer TS, and thus desired radiation properties may be implemented. Further, deterioration of image quality implemented from the display panel DP by the radiator 110 may be prevented.

FIG. 8 is a graph illustrating a gain according to a frequency of an antenna sample.

Specifically, a circular COP antenna dielectric layer 100 having a diameter of 32.8 mm (a length of a curved circumferential of about 103 mm) was prepared. The radiator 110 including the solid portion 112 and the mesh portion 115 having the shapes illustrated in FIG. 2 was formed along the curved circumference of the antenna dielectric layer 100. A length and/or a width of the mesh portion 115 was adjusted while a length of the solid portion 112 was fixed to 17.08 mm, and the first orientation angle θ1 was fixed to 15° to change the second orientation angle θ2 as shown in Table 1, thereby preparing antenna element samples.

An average gain of each antenna element sample was measured in a radiation chamber. Measured values of the average gain at 6.1 GHz and 7.3 GHz are shown in Table 1.

TABLE 1

| | angle (°) | | | | |
|---|---|---|---|---|---|
| | first | second | orientation | | |
| | orientation | orientation | angle | average gain(Avg. Gain) | |
| | angle | angle | difference | 6.1 | 7.3 |
| | (θ1) | (θ2) | (θc) | GHz | GHz |
| sample A | 15 | 20 | 5.00 | −5.7 dBi | −10.3 dBi |
| sample B | 15 | 25 | 10.00 | −5.3 dBi | −6.1 dBi |
| sample C | 15 | 40 | 25.00 | −4.1 dBi | −3.8 dBi |
| sample D | 15 | 55 | 40.00 | −4.6 dBi | −5.9 dBi |
| sample E | 15 | 60 | 45.00 | −5.5 dBi | −10.2 dBi |

Referring to FIG. 8 and Table 1, the other end portions of the solid portion 112 and the mesh portion 115 were separated to obtain dual resonance frequency peaks.

In samples B to D having the orientation angle difference θc from 10° to 40°, the gain exceeding −8 dBi was obtained at each of 6.1 GHz and 7.3 GHz, and a substantially dual resonance antenna element was implemented.

What is claimed is:

1. An antenna device comprising:
an antenna dielectric layer having a curved circumference; and
a radiator extending along the curved circumference of the antenna dielectric layer and having a curved shape, the radiator comprising a solid portion and a mesh portion,
wherein lateral sides of one end portions of the solid portion and the mesh portion are included in the same straight line, and lateral sides of the other end portions of the solid portion and the mesh portion are separated from each other.

2. The antenna device of claim 1, wherein the antenna dielectric layer has a circular shape, and the radiator has an arc shape of a circular sector.

3. The antenna device of claim 1, wherein an orientation angle difference between a first orientation angle of the solid portion and a second orientation angle of the mesh portion is in a range from 10° to 40°,
the first orientation angle is an angle between a virtual horizontal line extending from a starting point of an outer circumference of the solid portion in a tangential direction to the outer circumference of the solid portion and a first virtual straight line extending from the starting point of the outer circumference of the solid portion toward an end point of an inner circumference of the solid portion, and
the second orientation angle is an angle between the virtual horizontal line and a second virtual straight line extending from the starting point of the outer circumference of the solid portion toward an end point of an inner circumference of the mesh portion.

4. The antenna device of claim 3, wherein the orientation angle difference is in a range from 15° to 35°.

5. The antenna device of claim 3, wherein an outer circumference of the mesh portion and the inner circumference of the solid portion are in contact with each other.

6. The antenna device of claim 1, wherein a ratio of a length of the mesh portion relative to a length of the solid portion is 0.5 or greater, and less than 1.

7. The antenna device of claim 1, wherein a width of the mesh portion is greater than a width of the solid portion.

8. The antenna device of claim 1, wherein a ratio of a sheet resistance of the mesh portion relative to a sheet resistance of the solid portion of the radiator is in a range from 10 to 70.

9. The antenna device of claim 1, further comprising a circuit board that comprises:
a core layer; and
a signal wiring disposed on one surface of the core layer to be electrically connected to the radiator.

10. The antenna device of claim 9, wherein the circuit board further comprises a co-planar ground disposed at the same level as that of the signal wiring on the one surface of the core layer and spaced apart from the signal wiring.

11. The antenna device of claim 9, wherein the circuit board further comprises a vertical ground disposed on the other surface of the core layer opposite to the one surface to overlap the signal wiring.

12. The antenna device of claim 1, wherein the mesh portion consists of first conductive lines and second conductive lines which intersect each other to form openings.

13. The antenna device of claim 1, wherein the solid portion and the mesh portion have the same curvature.

14. The antenna device of claim 1, wherein the antenna device provides a dual resonance frequency in a frequency band ranging from 1 GHz to 15 GHz.

15. An electronic device, comprising:
a display panel; and
the antenna device according to claim 1 disposed on the display panel.

16. The electronic device according to claim 15, wherein the electronic device is provided as a smartwatch.

17. The electronic device according to claim 16, wherein the electronic device has a display area and a peripheral area, and
the solid portion of the radiator overlaps the peripheral area, and the mesh portion overlaps the display area.

18. The electronic device according to claim 15, further comprising a rear board disposed under the display panel and having a second connection structure mounted thereon,
wherein the antenna device further comprises a circuit board connected to the radiator and having a first connection structure mounted thereon, and
the circuit board is bent toward the rear board such that the first connection structure and the second connection structure are coupled to each other.

19. The electronic device of claim 18, wherein the first connection structure is a first connector or a pogo pin, and the second connection structure is a second connector coupled to the first connector or a pin pad connected to the pogo pin.
